(19) United States
(12) Patent Application Publication
(10) Pub. No.: US 2010/0202489 A1
(43) Pub. Date: Aug. 12, 2010

(54) TEMPERATURE SENSOR

(76) Inventor: Kevin Ronald McWilliams, Stratford upon Avon (GB)

Correspondence Address: Law Office of Ira S. Dorman, 330 Roberts street, Suite 200, East Hartford, CT, 06108, US

(21) Appl. No.: 12/733,279

(22) PCT Filed: Aug. 28, 2008
(86) PCT No.: PCT/GB2008/002929

§ 371 Date: Apr. 1, 2010

(30) Foreign Application Priority Data
Sep. 1, 2007 (GB) 0717051.7

(51) Int. Cl. G01K 7/00

(52) U.S. Cl. 374/163; 374/E07.001

(57) ABSTRACT

A temperature sensor for a radiant electric heater includes switch housing (7), first expansion element (3) secured at one end to the housing, and second expansion element (5) mounted such that free ends of the two elements are immovable relative to each other, the two expansion elements having different thermal expansion coefficients. Snap switch (11) is disposed within the housing and includes switch arm (9) provided with electrical contact (15). Electrically conducting support (29) is provided with counter contact (31), and resilient assembly (25, 27) is disposed in the housing and acts between the electrically conducting support and the switch arm and between the electrically conducting support and the end of the second expansion element. The resilient assembly includes spring (27) restrained against lateral movement and electrically insulating spacer (25) positioned between the spring and one of the switch arm and the electrically conducting support so as to electrically isolate the switch arm and the support.

This invention relates to a temperature sensor for a radiant electric heater.

Temperature sensors for radiant electric heaters, especially those used in cooking hobs, generally comprise a differential expansion member which is connected to a housing in such a manner that an element of the differential expansion member is adapted to operate a snap switch as a result of expansion and contraction of the differential expansion member. The operating element of the differential expansion member is generally biased in a direction away from the housing (and consequently the snap switch is generally biased towards an open position) by means of a spring, such as a coil spring, which engages with the housing.

Such a temperature sensor is described in U.S. Pat. No. 4,695,816 in which the expansion member comprises a metal tube enclosing a rod of ceramic material, the two elements being secured together in the region of the ends thereof remote from a housing. The tube is secured in the housing such that expansion and contraction of the expansion member results in axial movement of the rod within the housing. A coil spring acts in the axial direction of the rod and engages at one end with a spacer which acts indirectly on the end of the ceramic rod and on the arm of the snap switch, biasing the ceramic rod in a direction away from the housing and biasing the snap switch towards an open position. The other end of the coil spring acts against the inner wall of the housing.

A disadvantage of this arrangement is that the inner wall of the housing requires to be manufactured within close tolerances. Because the snap switch is switching electrical current, generally at mains voltage, the housing is made of an insulating material with sufficient structural strength to support the components of the switch in operation, such as a ceramic material. Manufacture within close tolerances is difficult with a ceramic material, such as steatite, which is conventionally used for the material of the housing and requires to be hardened by firing at high temperature. The firing process often leads to distortion of the housing and consequent inaccuracy in the pressure applied by the spring against the end of the inner ceramic rod and against the arm of the snap switch. This, in turn, leads to inaccuracies in the temperature at which the snap switch operates.

It is therefore an object of the present invention to provide a temperature sensor which overcomes or at least ameliorates the above disadvantage.

According to the present invention there is provided a temperature sensor for a radiant electric heater, the sensor comprising:

a switch housing;

a first expansion element secured at one end thereof to the housing;

a second expansion element mounted at its free end with a free end of the first expansion element such that the free ends of the two elements are immovable relative to each other, the first and second expansion elements having different coefficients of thermal expansion;

a snap switch disposed within the housing and including a switch arm provided with an electrical contact;

an electrically conducting support provided with a counter contact; and

a resilient assembly disposed in the housing and acting between the electrically conducting support and the switch arm and between the electrically conducting support and the end of the second expansion element, the resilient assembly including spring means restrained against lateral movement relative to an axial direction of the first and second expansion elements and an electrically insulating spacer positioned between the spring means and one of the switch arm and the electrically conducting support so as to electrically isolate the switch arm and the support.

The spring means may comprise a coil spring. Alternatively, the spring means may comprise a strip of resilient material, for example substantially in the shape of a C.

The spring means may be mounted on a projection, for example a substantially circular projection, formed on the electrically conducting support. Alternatively, the spring means may be mounted in a recess, for example a substantially circular recess, formed in the electrically conducting support. As a further alternative, the spring means may be secured to the electrically conducting support.

The insulating spacer may be substantially cylindrical.

The insulating spacer may be provided with a projection, for example of substantially circular cross-section, engaging with the spring means. Alternatively, the insulating spacer may be provided with a recess, for example of substantially circular cross-section, receiving the spring means. As a further alternative, the insulating spacer may be secured to the spring means.

The electrically conducting support may be secured to the housing. The electrically conducting support may extend substantially across the housing adjacent to a rear wall thereof. The counter contact may be arranged in the region of one end of the support and a connector for electrical current may be arranged in the region of an opposite end of the support, the support passing through a wall of the housing.

The end of the second expansion element may bear against the switch arm. Alternatively, the end of the second expansion element may pass through the switch arm and engage with the insulating spacer.

The switch arm may be secured to an electrically conducting support. The electrically conducting support may be secured to the housing. The electrically conducting support may extend through a wall of the housing and may be provided in the region of a free end thereof with a connector for electrical current.

The first expansion element may be in the form of a tube and the second expansion element may be in the form of a rod arranged within the tube.

The first expansion element may be made of a metallic material. The second expansion element may be made of a ceramic, glass or metal having lower thermal expansion that the first expansion element.

The spring arm may be provided with an articulation point about which the arm is able to flex. The articulation point may be substantially V-shaped with the apex thereof extending away from the end of the second expansion element. Alternatively, the articulation point may be substantially V-shaped with the apex thereof extending towards and engaging with the end of the second expansion element.

For a better understanding of the present invention and to show more clearly how it may be carried into effect reference will now be made, by way of example, to the accompanying drawings in which:

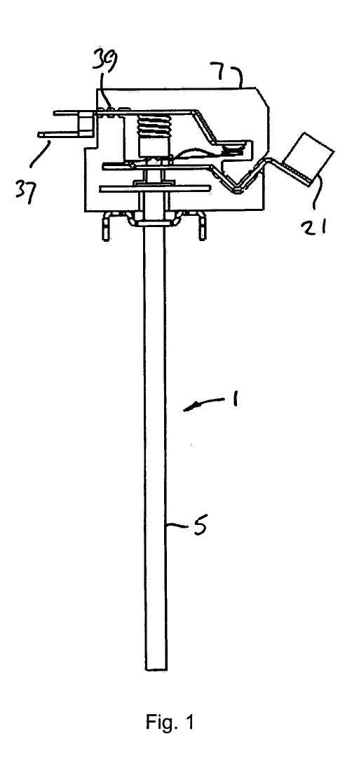

FIG. 1 is a diagrammatic illustration of one embodiment of a temperature sensor according to the present invention;

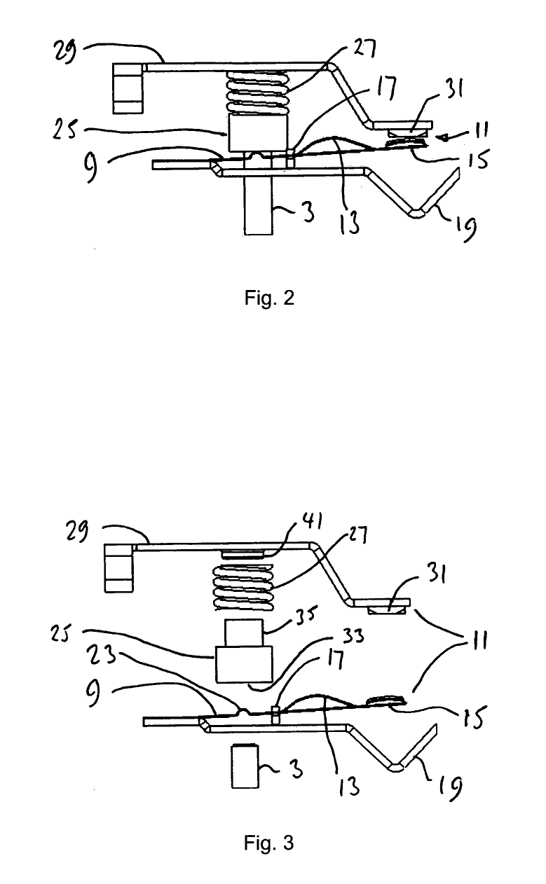

FIG. 2 is a diagrammatic illustration of part of the temperature sensor of FIG. 1; and

FIG. 3 is a diagrammatic illustration of the part of the temperature sensor of FIG. 2 in exploded form.

The temperature sensor shown in the figures comprises a differential expansion member 1 in the form if two elongate expansion elements 3, 5 which have significantly different coefficients of thermal expansion. In particular, expansion element 3 may comprise a tube of metallic material of relatively high coefficient of thermal expansion, while expansion element 5 may comprise a rod of ceramic material of relatively low coefficient of thermal expansion arranged within the tube 3.

The free ends of the expansion elements 3 and 5 are mounted together in such a manner that they cannot move relative to each other. The other end of the expansion element 3 is secured within a housing 7, while the other end of the expansion element 5 is free to move within the housing 7. Consequently the ends of the differential expansion member within the housing 7 move relative to each other, in the axial direction of the member 1, as the expansion member is heated and cooled, with the result that the end of the rod-form expansion element 5 moves outwardly relative to the housing as the expansion member is heated and moves inwardly relative to the housing as the expansion member is cooled.

The end of the rod-form expansion element 5 within the housing 7 passes through an actuating arm 9 of a snap switch 11, the snap switch also including a reaction arm 13 which creates the snap effect of a contact 15 provided in the region of a free end of the actuating arm by engagement with a retaining member 17 formed on a support 19 for the actuating arm 9 in such a way that the reaction arm 13 is deformed under tension so as to urge the free end of the actuating arm either towards or away from a counter contact 31 so as to control the supply of electrical power to a radiant electric heater (not shown) of which the temperature sensor forms a part in a manner well known to the skilled person. The actuating arm 9 of the snap switch 11 is secured to the support 19, for example by welding.

The support 19 extends through a wall of the housing 7 and provides a connector 21 for supplying electrical current to the movable contact 15. The support 19 is deformed substantially into a V-shape where it passes through the wall of the housing 7 so as to secure the support in a predetermined position within the housing.

At the point where the end of the rod-form expansion element 5 passes through the actuating arm 9 of the snap switch 11, the actuating arm is formed with an articulation point 23 in the form of a substantially V-shaped deformation with the apex of the deformation being directed towards and bearing against an insulating spacer 25, for example of ceramic material. That is, in a direction away from the differential expansion member 1. The insulating spacer may be substantially cylindrical, although, of course, it may have other forms, such as of square or octagonal cross-section.

The insulating spacer 25 is urged against the articulation point 23 of the actuating arm 9 of the snap switch by means of a coil spring 27 which extends substantially in the axial direction of the differential expansion member 1 and engaging at its other end with a support 29 for the counter contact 31. The insulating spacer 25 is formed at one end thereof with a surface 33 adapted to engage the articulation point 23 of the articulation arm 9 of the snap switch 11 and to engage the end of the rod-form expansion member 5 within the housing 7. For example, the engaging surface of the insulating spacer 25 may be substantially planar. The other end of the insulating spacer 25 comprises a spring-engaging portion 35. As illustrated, the spring-engaging portion 35 is of reduced cross-sectional area compared with the remainder of the spacer in order that the portion 35 can fit within the coil spring 27. Ideally, the spring-engaging portion 35 is substantially cylindrical, although it may have other configurations. Equally, it is possible that the spring-engaging portion 35 could engage with an external surface of the spring or have any other configuration suitable for resisting lateral displacement of the spring 27 and to ensure as far as possible that movement of the spring 35 is constrained to the axial direction of the differential expansion member 1.

As an alternative, the end of the rod-form expansion element 5 need not pass through the actuating arm 9 of the snap switch 11 and may instead sandwich the actuating arm 9 between the end of the expansion element 5 and the insulating spacer 25 so as to urge the rod-form expansion member 5 in a direction away from the housing 7 in an indirect manner. The insulating spacer 25 still engages with the actuating arm 9, for example at the articulation point 23, and serves to isolate the actuating arm 9 and the contact 15 provided thereon from the support 19 and the counter contact mounted thereon.

As illustrated, the support 29 for the counter contact 31 passes through the wall of the housing 7 and is provided with a connector 37 for connection to a source of electrical current for energising the radiant electrical heater (not shown). The support 29 is deformed at 39 where it passes through the wall of the housing 7 so as to secure the support to the housing.

Lateral displacement of the coil spring 27 would normally also be resisted by provision of a spring-engaging abutment on the housing 7. However, the support 29 for the counter contact 31 is provided with a spring-engaging portion 41 which in the illustrated embodiment comprises a substantially circular projection dimensioned to fit within the coil spring 27 so as to resist lateral displacement of the coil spring. It should be noted, however, that the spring-engaging portion could have other configurations, such as a substantially circular recess within which the coil spring is adapted to fit so as to resist lateral displacement of the end of the coil spring.

As illustrated, the support 29 for the counter contact 31 extends across a rear wall of the housing 7 from the counter contact 31 which is in the region of one side wall of the housing, to the connector 37 which is arranged externally of an opposed side wall of the housing 7. The spring-engaging portion 41 is therefore conveniently provided as a deformation formed in the support 29, such as by pressing. In this way the location and dimensions of the spring-engaging portion 41 can be readily determined with considerable accuracy in a manner which is repeatable and not subject to error as a result of heating the support for the portion 41.

Clearly, the spring 27 need not be formed as a coil spring, but could have other configurations. For example, the spring may be made of resilient strip material, generally in the form of a C. Such a substantially C-shaped spring may be engaged with the support 29 for the counter contact 31 in the region of one end of the spring and may be engaged with the insulating spacer 25 in the region of the other end of the C-shaped spring.

1. A temperature sensor for a radiant electric heater, the sensor comprising:
a switch housing (7);
a first expansion element (3) secured at one end thereof to the housing;
a second expansion element (5) mounted at its free end with a free end of the first expansion element such that the free ends of the two elements are immovable relative to each other, the first and second expansion elements having different coefficients of thermal expansion;
a snap switch (11) disposed within the housing and including a switch arm (9) provided with an electrical contact (15);
an electrically conducting support (29) provided with a counter contact (31); and
a resilient assembly (25, 27) disposed in the housing and acting between the electrically conducting support and the switch arm and between the electrically conducting support and the end of the second expansion element, the resilient assembly including spring means (27) restrained against lateral movement relative to an axial direction of the first and second expansion elements and an electrically insulating spacer (25) positioned between the spring means and one of the switch arm and the electrically conducting support so as to electrically isolate the switch arm and the support.

2. A temperature sensor as claimed in claim 1, wherein the spring means (27) comprises a coil spring.

3. A temperature sensor as claimed in claim 1, wherein the spring means (27) comprises a strip of resilient material.

4. A temperature sensor as claimed in claim 3, wherein the spring means (27) is substantially in the shape of a C.

5. A temperature sensor as claimed in claim 1, wherein the spring means (27) is mounted on a projection (41) formed on the electrically conducting support (29).

6. A temperature sensor as claimed in claim 5, wherein the projection (41) is substantially circular.

7. A temperature sensor as claimed in claim 1, wherein the spring means (27) is mounted in a recess formed in the electrically conducting support (29).

8. A temperature sensor as claimed in claim 7, wherein the recess is substantially circular.

9. A temperature sensor as claimed in claim 1 wherein the spring means (27) is secured to the electrically conducting support (29).

10. A temperature sensor as claimed in claim 1 wherein the insulating spacer (25) is substantially cylindrical.

11. A temperature sensor as claimed in claim 1, wherein the insulating spacer (25) is provided with a projection (35) engaging with the spring means (27).

12. A temperature sensor as claimed in claim 11, wherein the projection (35) is of substantially circular cross-section.

13. A temperature sensor as claimed in claim 1 wherein the insulating spacer (35) is provided with a recess receiving the spring means.

14. A temperature sensor as claimed in claim 13, wherein the recess is of substantially circular cross-section.

15. A temperature sensor as claimed in claim 1, wherein the insulating spacer (25) is secured to the spring means (27).

16. A temperature sensor as claimed in claim 1, wherein the electrically conducting support (29) is secured to the housing (7).

17. A temperature sensor as claimed in claim 16, wherein the electrically conducting support (29) extends substantially across the housing (7) adjacent to a rear wall thereof

18. A temperature sensor as claimed in claim 16, wherein the counter contact (31) is arranged in the region of one end of the support (29) and a connector (37) for electrical current is arranged in the region of an opposite end of the support, the support passing through a wall of the housing (7).

19. A temperature sensor as claimed in claim 1, wherein the end of the second expansion element (5) bears against the switch arm (9).

20. A temperature sensor as claimed in claim 1, wherein the end of the second expansion element (5) passes through the switch arm (9) and engages with the insulating spacer (25).

21. A temperature sensor as claimed in claim 1, wherein the switch arm (9) is secured to an electrically conducting support (19).

22. A temperature sensor as claimed in claim 21, wherein the electrically conducting support (19) is secured to the housing (7).

23. A temperature sensor as claimed in claim 21, wherein the electrically conducting support (19) extends through a wall of the housing (7) and is provided in the region of a free end thereof with a connector (21) for electrical current.

24. A temperature sensor as claimed in claim 1, wherein the first expansion element (3) is in the form of a tube and the second expansion element (5) is in the form of a rod arranged within the tube.

25. A temperature sensor as claimed in claim 1, wherein the first expansion element (3) is made of a metallic material.

26. A temperature sensor as claimed in claim 25, wherein the second expansion element (5) is made of a material selected from ceramic, glass and metal having lower thermal expansion that the first expansion element (3).

27. A temperature sensor as claimed in claim 1, wherein the spring arm (9) is provided with an articulation point (23) about which the arm is able to flex.

28. A temperature sensor as claimed in claim 27, wherein the articulation point (23) is substantially V-shaped with the apex thereof extending away from the end of the second expansion element (5).

29. A temperature sensor as claimed in claim 27, wherein the articulation point (23) is substantially V-shaped with the apex thereof extending towards and engaging with the end of the second expansion element (5).
